(19) United States
(12) Patent Application Publication
(10) Pub. No.: US 2004/0081793 A1
(43) Pub. Date: Apr. 29, 2004

(54) Trench cover

(76) Inventor: David Vincent Byrne, Dublin (IE)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/686,632

(22) Filed: Oct. 17, 2003

Related U.S. Application Data
(63) Continuation of application No. PCT/IE02/00046, filed on Apr. 17, 2002.

(30) Foreign Application Priority Data
Apr. 17, 2001 (IE) S010375

(51) Int. Cl. B32B 3/06

(52) U.S. Cl. 428/99

(57) ABSTRACT

A number of trench cover members (2) are interlinked to form a cover for a trench (4). Oppositely directed trench engaging arms (27, 28) are movable relative to a cover member (2) to facilitate adjustment to a desire width of trench. A trench engaging arm (27, 28) is adjustable to one of a number of discrete locations corresponding to a desired width. Fixing bolts (104, 105) lock the trench elements (27, 28) to the desired width.

### INTRODUCTION

The invention relates to a cover for temporarily covering a trench made in a footpath or roadway.

Digging trenches for laying cables, pipes and the like is extremely labour intensive. There are severe constraints on efficient digging because of the need to complete the digging, fitting and filling operation as quickly as possible. This is especially difficult in situations where the path or roadway must be kept open. Thus, a considerable amount of work is required to backfill trenches while the trench digging work is ongoing. Regularly, a large proportion of the available working day is involved in temporary backfilling and the removal of the backfill to allow the work to continue. This is a major cost factor as not only is there a high labour content but also backfill is generally a waste product that cannot be used as permanent trench filling.

Various attempts have been made to provide a trench cover to temporarily cover a trench. Such trench covers however have a number of disadvantages and are consequently used infrequently, backfilling being the preferred option.

U.S. Pat. No. 4,801,483 describes a ground opening cover with anchoring holes for anchoring the cover in place. It is not practical to temporarily cover a trench with such plates as each plate must be anchored separately and each of these anchors must be released to remove the cover.

GB-A-2305954 describes a temporary trench cover comprising an upper plate with depending walls for inserting into the trench. An angle piece is secured to one depending wall to provide a connection means in the form of a channel having an upwardly opening mouth into which an opposite depending wall of an adjacent plate is engaged. While such an arrangement prevents longitudinal movement between adjacent cover plates the plates are easily removed by pulling the plates upwardly using the finger receiving apertures. Thus, the plates are not secured against unauthorised removal. In addition, the arrangement does not facilitate covering of a trench which is not straight.

EP-A-0431777 describes a cover for temporarily covering a trench which is releasably engagable with an adjacent cover. The cover is a tight fit in a trench and the arrangement does not facilitate relative movement between adjacent cover elements. Further, unauthorised removal is not prevented as the covers can be relatively easily removed by moving a cover out of the general plane of the assembly.

GB-A-2 321 486 describes a temporary trench cover comprising a hollow shell of plastics material with a downwardly protruding portion to define lateral abutment faces which are spaced apart by a width corresponding to the width of the trench so as to engage the side walls of the trench. The cover may have a part-circular tongue at one end for engaging in a corresponding part-circular recess defined by an open-ended socket of an adjacent element to allow adjacent cover elements to be articulated. Such an arrangement is difficult to manufacture and the covers can be relatively easily removed by unauthorised personnel by moving a cover out of the general plane of the assembly. In addition, while the arrangement illustrates relative movement between adjacent covers, the gaps between adjacent covers present a hazard as, for example, a bicycle wheel may become wedged in the gap with attendant safety problems.

In my WO 01/21898 A I have described a temporary trench cover plate which addresses the problems with such known cover plates. The relevant contents of this specification are incorporated herein by reference.

In some cases it is desirable to provide a temporary trench cover plate which can accommodate a range of trench widths. This invention is directed towards providing such a cover.

### STATEMENTS OF INVENTION

According to the invention, there is provided a cover for a trench, the cover comprising:—

a cover member for extending over a trench;

the cover member comprising a pair of ground engaging portions bridged by a central trench covering portion; and

a trench element depending from the cover member to confine the cover member with respect to a trench;

the trench element being movable relative to the cover member to facilitate adjustment to a desired width of trench.

In one embodiment of the invention, the cover comprises at least two trench elements. Preferably the two elements are movable relative to the cover member to facilitate adjustment to a desired width of trench.

Because both of the trench engaging elements are movable relative to the cover member, this enables the cover to be adjusted to suit the width of the trench, while ensuring tie cover may be positioned centrally over the trench with substantially equal amounts of the ground engaging portions in contact with the ground on each side of the trench.

A single relatively compact cover may be adjusted to cover a large range of trenches of different widths in a simple, efficient manner.

Also in one case because the trench engaging elements are movable longitudinally rather than rotatably movable, the orientation of the trench elements may be predetermined for any width of trench. Thus, a uniform predictable performance is achieved.

The cover may comprise locking means to releasably lock a trench element in a desired position relative to the cover member. The locking means may be releasable on site and/or off site. Ideally the locking means comprises a fixing pin extendable through an opening in the trench element and an aligned opening in the cover member.

In a preferred embodiment of the invention the element is movable between a number of discrete locations. Ideally the trench element and/or the cover member comprises a number of openings to receive a corresponding protrusion on the other of the trench element and/or cover member corresponding to a discrete location. The protrusion may be provided on the underside of the cover member and the openings are provided in the trench element. Preferably the trench element has an elongate slot with a number of enlarged holes at discrete locations along the slot. Ideally the protrusion substantially fills a discrete hole in the trench element. Most preferably the protrusion comprises an elongate extension for engagement in the slot in the trench element.

In another embodiment, the cover comprises a guide on the underside of the cover. The guide is preferably defined by a pair of ribs depending from the underside of the cover, the ribs being spaced apart to receive a portion of the trench element therebetween.

In one case the trench element comprises a handle portion to facilitate gripping of the trench element during adjustment. The handle portion enables a user to easily and quickly grip the trench engaging element to move the trench engaging element to a desired position.

Ideally the trench elements are oppositely directed.

In a further preferred embodiment the cover comprises interlink means comprising a first interlink means at one transverse side of the cover member and a complementary second interlink means at an opposite transverse side of the cover member, one of the first or second interlink means being engagable underneath the other of the first and second interlink means of a like cover on assembly. Ideally the cover is relatively movable with respect to an adjacent cover to follow the contour of a trench.

In another aspect the invention provides a cover assembly for a trench, the assembly comprising a plurality of covers of the invention.

### BRIEF DESCRIPTION OF THE DRAWINGS

The invention will be more clearly understood from the following description of an embodiment thereof, given by way of example only, with reference to the accompanying drawings, in which:—

FIG. 1 is a perspective view from above of a trench cover according to the invention;

FIG. 2 is a perspective view from beneath of the cover of FIG. 1;

FIG. 3 is a plan view from beneath of the cover of FIG. 1;

FIG. 4 is an end view of the cover in situ in a trench;

FIG. 5 is a plan view from beneath the cover with trench elements removed:

FIGS. 6(a) and 6(b) are plan views of trench elements from beneath the cover;

FIG. 7 is a cross-sectional view of the mounting of a trench element to the cover plate;

FIG. 8 is a cross-sectional view illustrating the mounting of a trench element to the cover plate;

FIG. 9 is a plan view from beneath of a mounting element of a cover plate;

FIG. 10 is a perspective view of a number of trench covers in position covering a trench;

FIGS. 11 and 12 are cross-sectional views illustrating assembly of a number of trench covers according to the invention; and

FIG. 13 is a plan view of a number of trench covers covering another trench.

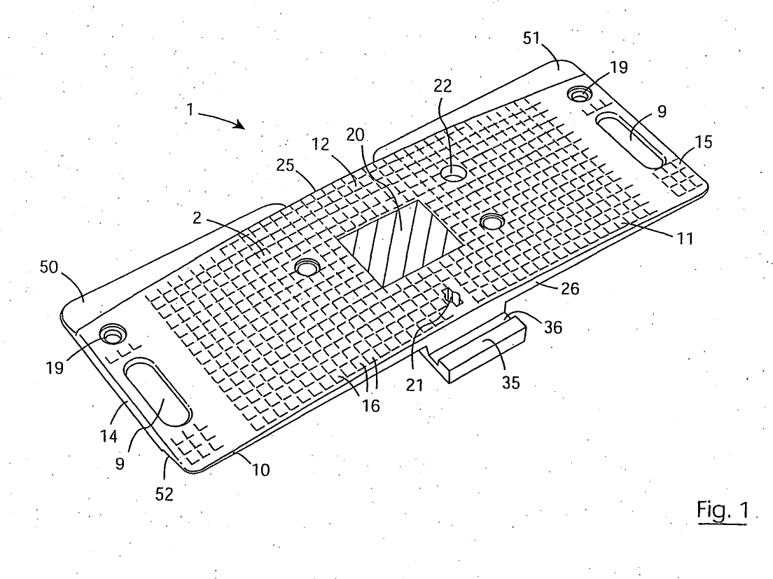

### DETAILED DESCRIPTION

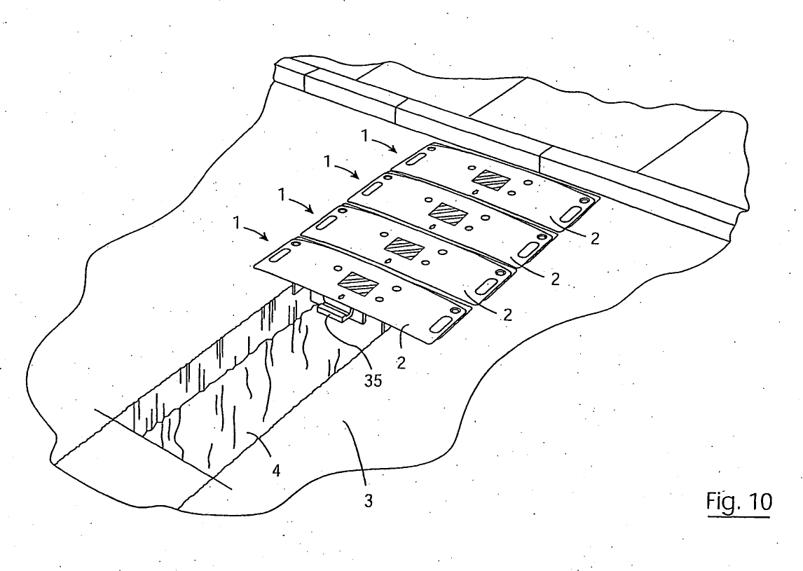

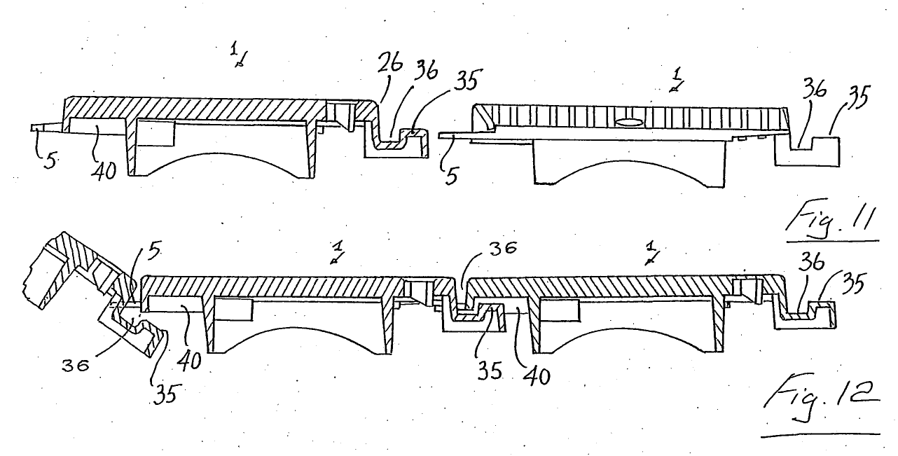

Referring to the drawings, there is illustrated a cover 1 according to the invention for a trench 4. Covers 1 are used to cover a trench 4 in the ground 3, as illustrated in FIG. 10, and a number of the cover elements 1 may be interlinked to follow the contour of the ground 3 in which the trench 4 is dug, as illustrated in FIGS. 11 to 13. In FIG. 10 the covers 1 are shown covering a trench 4 which follows a relatively straight course, while in FIG. 13 the covers 1 are shown covering a trench 200 which follows an irregular course.

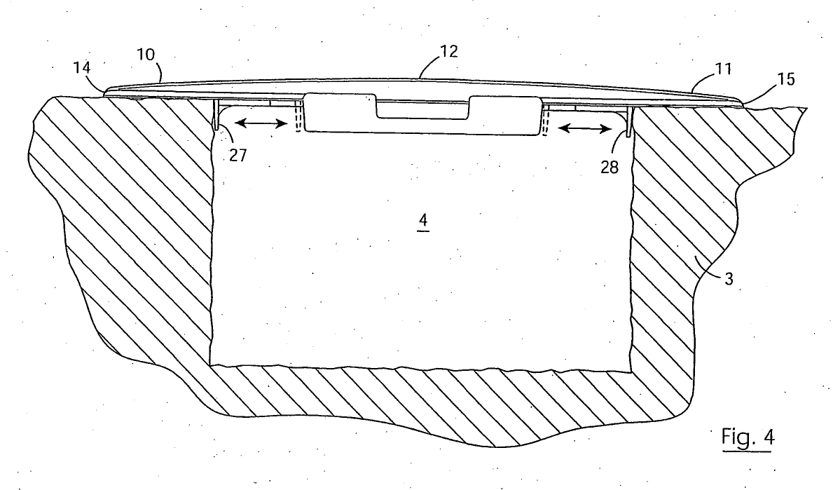

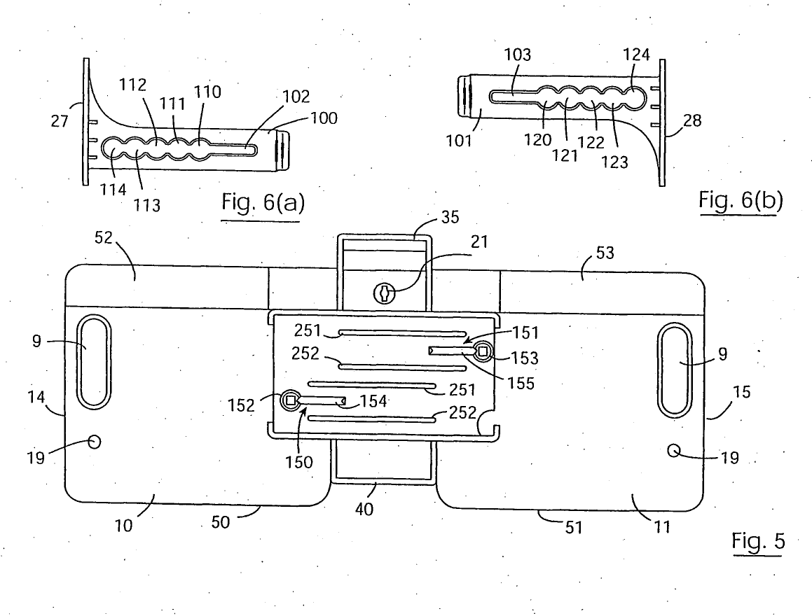

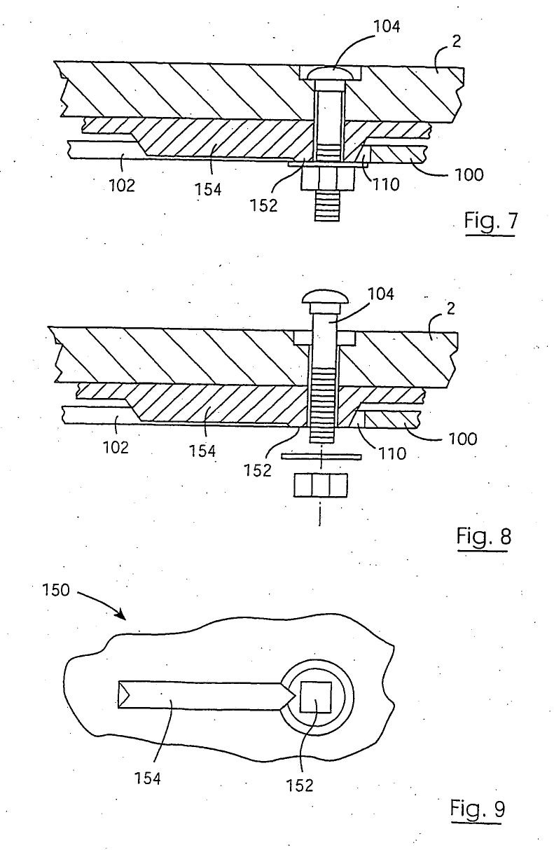

The cover 1 comprises a cover member 2 for extending over a trench 4, especially in a roadway. The cover member 2 comprises a pair of ground engaging portions 10, 11 bridged by a central trench covering portion 12. The cover member 2 is of a generally convex shape in transverse cross section (FIG. 4), the side portions 10, 11 reducing in cross section towards opposite marginal edges 14, 15 of the cover member 2 to define a slight ramp to facilitate vehicle wheels and the like passing thereover. The exposed upper surface of the cover member 2 has anti-slip formations which in this case are defined by generally square shaped raised portions 16. Anchor holes 19 are provided in the ground engaging portions 10, 11 to facilitate anchoring to the ground 3, if desired. A central recessed area 20 is provided for attachment of a reflector strip or the like. To facilitate erection of a post for a warning flag, sign or the like the cover member 2 has a mounting hole 21. Another recess 22 is provided to receive a coding means such as an identity tag or transponder unit to uniquely identify the cover 1 for tracing and the like. The ground engaging portions 10, 11 also have slots therein defining carrying handles 9 for the cover 1.

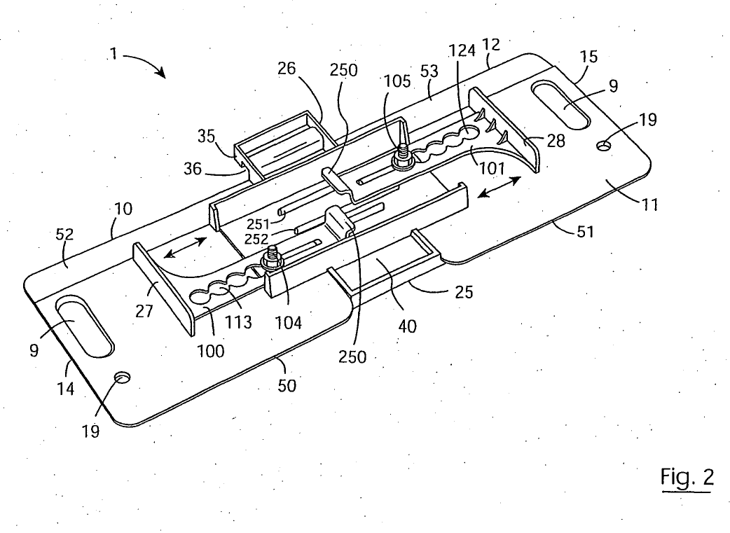

The cover member 2 has a pair of transverse sides 25, 26 extending transversely between opposite marginal edges 14, 15. Confinement means in the form of trench elements 27, 28 confine the cover 1 with respect to the opening of the trench 4. Referring in particular to FIGS. 2 to 4, it will be noted that the two trench elements 27, 28 depend from the central trench covering portion 12 of the cover member 2, and are oppositely directed so that, in use, they can engage opposite side walls of a trench 4.

The trench elements 27, 28 are linearly movable relative to the cover member 2 to facilitate adjustment to a desired width of trench. In particular, the trench engaging elements 27, 28 comprise arms 100, 101 with elongate slots 102, 103 respectively for adjustment relative to the cover member 2.

Means to lock the trench engaging elements 27, 28 in a desired position relative to the cover member 2 are provided in the form of fixing pins 104, 105 respectively. The pins 104, 105 are extendable through aligned openings in the arms 100, 101 and the cover member 2 to lock the trench engaging elements 27, 28 in a particular position. In this case, the fixing pins 104, 105 are provided in the form of threaded bolts coupled to corresponding threaded nuts.

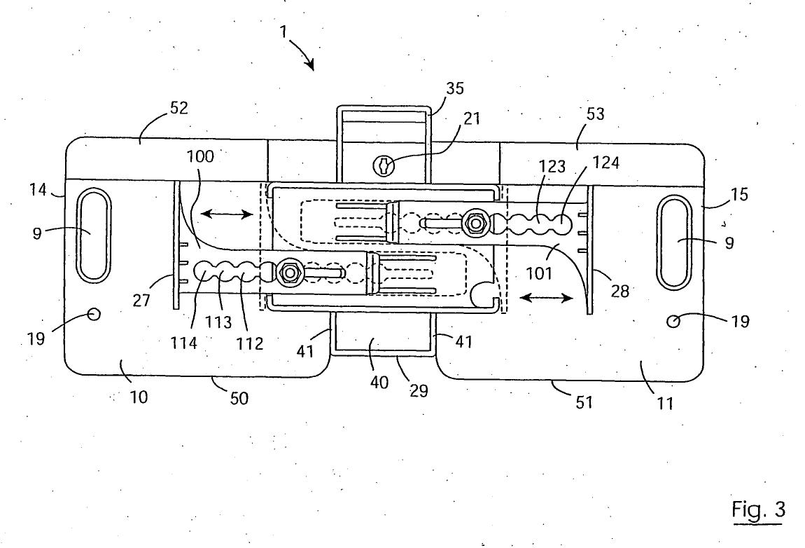

As illustrated particularly in FIGS. 3 and 6, each slot 102, 103 has a range of discrete enlarged openings 110. Each trench element 27, 28 is movable between a number of discrete locations as defined by the enlarged openings 110, 120. The cover has two protrusions 156, 151 on the underside thereof for engagement in the slots 102, 103 and openings 110, 120. The protrusions 150, 151 each have an enlarged portion 152, 153 for engagement in one of the openings 110, 120 respectively in the trench elements 27, 28. Each protrusion 150, 151 also comprises an elongate extension 154, 155 for engagement in the slots 102, 103. In this case there are five discrete enlarged openings 110, 120 in each of the trench elements 27, 28. Working from the centre line of the cover 1 outwardly these are assigned references 110, 111, 112, 113, 114 for the trench element 27 and 120, 121, 122, 123, 124 for the trench element 28. When the trench elements 27, 28 are moved inwardly to their fullest extent such that the holes 114, 124 are engaged this corresponds to a given trench width of say 300 mm. When the trench elements 27, 28 are moved outwardly to the fullest extent such that the holes 110, 120 are engaged, this corresponds to a maximum trench width of say 500 mm. Adjustment of the trench element 27, 28 from one hole to the adjacent hole represents an extension of the trench element 27, 28 by a fixed distance, say 25 mm. Thus, engagement of the holes 111 and 121 corresponds to a trench width of 450 mm, holes 112 and 122 to a trench width of 400 mm, and holes 113 and 123 to a trench width of 350 mm. To move the trench element 27, 28 from one hole 110, 120 to the next the fixing bolts 104, 105 are released and the trench element 27, 28 is lifted off the protrusion 150, 151 and moved linearly until the protrusion 152, 153 is in line with the desired hole 110, 120. The trench element 27, 28 is then engaged with the protrusion 150, 151 and the fixing bolts 104, 105 tightened to fix the trench elements 27, 28 to the cover member 2 in position corresponding to the desired width. The trench element 27, 28 may have an imprint therein adjacent to each hole 110, 120 to indicate the corresponding trench width to a user.

Thus, to adjust the distance between the trench engaging elements 27, 28 to correspond to the width of a trench 4 to be covered, one or both fixing pins 104, 105 are released, the arms 100, 101 linearly adjusted and the fixing pins 104, 105 are then re-locked. The trench engaging elements 27, 28 are adjustable to accommodate a range of trench widths, typically from 300 to 500 mm. The elements 27, 28 are preferably incrementally adjustable in increments of typically 25 mm.

Each arm 100, 101 has a depending handle formation 250 at the opposite end to the fixing pins 104, 105 (FIG. 2). The handles 250 enable a user to easily grip and move the trench engaging elements 27, 28.

Protective side walls 251, 252, which are fixed relative to the cover member 2, also depend from the central trench covering portion 12 of the cover member 2 on both sides of the arms 100, 101. The side walls 251, 252 guide and protect the movable arms 100, 101.

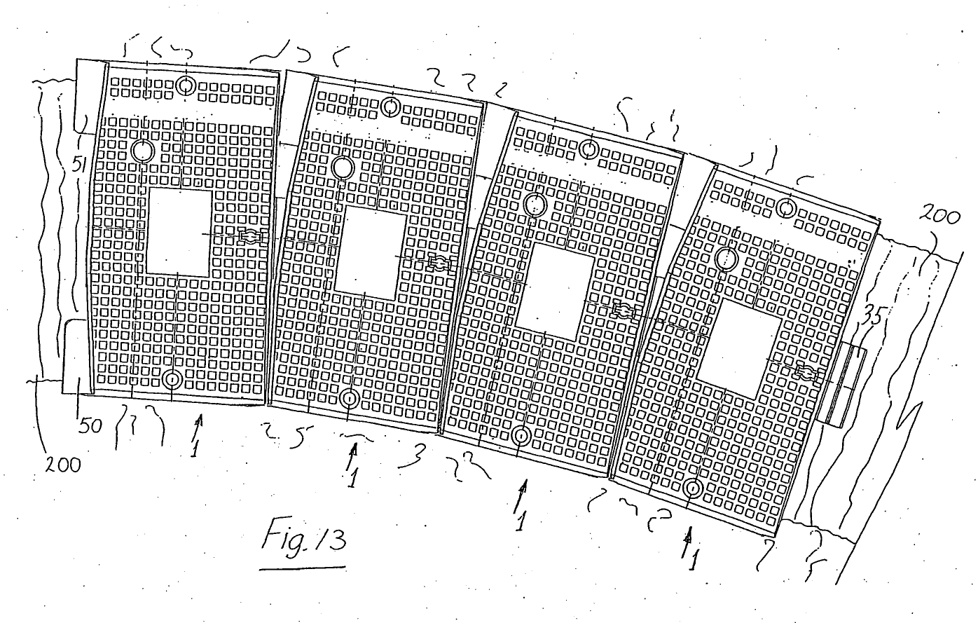

Interlink means are also provided in the form of a first male interlink means and a second female interlink means, the interlink means of adjacent like covers 1 being interengagable on assembly of the covers 1 as illustrated in FIGS. 11 and 12.

In this case, the male interlink means comprises a head part 35 projecting from the transverse side 26 of the cover member 2. The head part 35 has an area of reduced cross section defining a neck 36 and is located centrally of the transverse side 26.

The female interlink means comprises a downwardly opening slot 40 at the transverse side 25. The slot 40 is defined in the underside of the cover member 2 by downwardly extending walls 41 and portion of the transverse wall 29. The width of the slot 40 is oversize with respect to the width of the head part 35 of the male interlink to permit limited relative movement between adjacent covers 1 on assembly so that the covers 1 can follow the contour of the ground 4. Similarly, the length of the head part 35 is less than the length of the recess 40. It will be noted that the upper ends of the head part 35 are tapered to facilitate assembly of the head part 35 into the recess 40.

The interlink means in this case also comprises a pair of end wings 50, 51 which extend from the transverse side 25. The end wings 50, 51 are located on either side of the recess 40 and extend generally from the ground engaging portions 10, 11 of the cover member 2 respectively. On assembly, the end wings 50, 51 are received underneath an adjacent cover 1. In this case, the end wings 50, 51 are received in recessed areas 52, 53 respectively flanking the head part 35.

The end wings 50, 51 engaging underneath an adjacent cover 1, in combination with the inter-engagement of the head part 35 in the slot 40 secures adjacent covers 1 together in such a way as to facilitate relative movement between adjacent covers 1 to follow the contour of a trench 4.

Because both of the trench engaging elements 27, 28 may be moved relative to the cover member 2, this enables the cover 1 to be adjusted so that the cover 1 is confined with respect to the trench 4 regardless of the trench width, while also enabling the cover 1 to be positioned centrally over the trench 4 with substantially equal amounts of the ground engaging portions 10, 11 in contact with the ground 3 on each side of the trench 4. The width adjustment may be made at a depot or on site so that the cover 1 is configured for a particular trench size.

In use, the cover 1 is located over a trench 4 in the ground 3 with the ground engaging portions 10, 11 resting on the ground 3 either side of the trench 4 and the central portion 12 bridging the trench 4.

Like covers 1 are then interengaged, as illustrated in FIGS. 11, 12 by locating the head part 35 of one cover 1 into the slot 40 of an adjacent cover 1. The end wings 50, 51 of one cover 1 are also received in the recessed areas 52, 53 of an adjacent cover 1 during interlinking.

In this manner, a plurality of covers 1 may be interlinked to form a cover assembly over a trench 4 of any length or configuration, as illustrated in FIGS. 10 and 13.

Because the trench cover 1 of the invention permits a degree of relative movement between adjacent covers 1 of an assembly, it is possible for the covers 1 to follow a curvilinear course, for example to cover a curved trench 200, as illustrated in FIG. 13.

On assembly, end covers 1 may be anchored to the ground 3 and because of the inter-engagement on both transverse sides 25, 26 none of the covers 1 in the assembly can be removed by an unauthorised person. This prevents theft and also enhances the safety aspects of the assembly. In addition, the end wings 50, 51 have the important advantage that they at least partially occlude any gap between adjacent covers 1 on assembly. This is also an important safety feature as there is no gap on which to snag a bicycle wheel or the like.

At least one transverse side, in this case the transverse side 25 is shaped to facilitate limited relative movement between side edges 25, 26 of adjacent covers 1. In this case the transverse side 25 is of generally convex curvilinear shape.

The covers 1 are readily assembled as described above to form a rigid temporary trench cover that can be easily disassembled. Most importantly, controlled relative movement is allowed so that the cover 1 follows the contour of the ground 3, preferably in both the vertical and horizontal planes. This ensures a particularly safe and even temporary surface over a trench opening 4.

The covers 1 may include a code tracking means such as a transponder which may be housed within the cover 1 to allow the location of the cover 1 to be determined from a remote location. In this way the hire and use of the covers 1 can be controlled.

The invention provides a simple yet extremely effective temporary cover 1 for a range of trench widths. Adjacent covers 1 are readily interconnected as described above. The fittings allow the cover 1 to readily follow both the contour of the ground 3 in which the trench 4 is dug and also the path of the trench 4.

The trench cover 1 may be anchored into position. Usually, the cover 1 will be anchored at either end by, for example, an anchor bolt which may subsequently be temporarily covered. The cover 1 may also be anchored to the trench 4 at any suitable point, for example at 5 m length. The anchoring may be achieved by a releasable hook linkage between the cover 1 and a trench strut.

The trench cover assembly of the invention is easily handled and can therefore be used as a substitute for backfilling. Thus, the labour force can be concentrated on the trench digging operation, which is thereby optimised.

Many variations on the specific embodiments of the invention will be readily apparent, and accordingly the invention is not limited to the embodiments hereinbefore described, with reference to the accompanying drawings, which may be varied in construction and detail.

1. A cover for a trench, the cover comprising:—
a cover member for extending over a trench;
the cover member comprising a pair of ground engaging portions bridged by a central trench covering portion; and
a trench element depending from the cover member to confine the cover member with respect to a trench;
the trench element being movable relative to the cover member to facilitate adjustment to a desired width of trench.

2. A cover as claimed in claim 1 comprising at least two trench elements.

3. A cover as claimed in claim 2 wherein the two elements are movable relative to the cover member to facilitate adjustment to a desired width of trench.

4. A cover as claimed in claim 1 wherein the cover comprises locking means to releasably lock a trench element in a desired position relative to the cover member.

5. A cover as claimed in claim 4 wherein the locking means comprises a fixing pin extendable through an opening in the trench element and an aligned opening in the cover member.

6. A cover as claimed in claim 1 wherein the element is movable between a number of discrete locations.

7. A cover as claimed in claim 6 wherein the trench element and/or the cover member comprises a number of openings to receive a corresponding protrusion on the other of the trench element and/or cover member corresponding to a discrete location.

8. A cover as claimed in claim 7 wherein the protrusion is provided on the underside of the cover member and the openings are provided in the trench element.

9. A cover as claimed in claim 8 wherein the trench element has an elongate slot with a number of enlarged holes at discrete locations along the slot.

10. A cover as claimed in claim 9 wherein the protrusion substantially fills a discrete hole in the trench element.

11. A cover as claimed in claim 10 wherein the protrusion comprises an elongate extension for engagement in the slot in the trench element.

12. A cover as claimed in claim 1 comprising a guide on the underside of the cover.

13. A cover as claimed in claim 12 wherein the guide is defined by a pair of ribs depending from the underside of the cover, the ribs being spaced apart to receive a portion of the trench element therebetween.

14. A cover as claimed in claim 1 wherein the trench element comprises a handle portion to facilitate gripping of the trench element during adjustment.

15. A cover as claimed in claim 2 wherein the trench elements are oppositely directed.

16. A cover as claimed in claim 1 wherein the cover comprises interlink means comprising a first interlink means at one transverse side of the cover member and a complementary second interlink means at an opposite transverse side of the cover member, one of the first or second interlink means being engagable underneath the other of the first and second interlink means of a like cover on assembly.

17. A cover as claimed in claim 16 wherein the cover is relatively movable with respect to an adjacent cover to follow the contour of a trench.

18. A cover assembly for a trench, the assembly comprising a plurality of covers as claimed in claim 1.
